(19) United States
(12) Patent Application Publication
(10) Pub. No.: US 2014/0032583 A1
(43) Pub. Date: Jan. 30, 2014

(54) Multi-Resolution Exploration of Large Image Datasets

(71) Applicants: Sergey Ioffe, Mountain View, CA (US); Yushi Jing, San Francisco, CA (US)

(72) Inventors: Sergey Ioffe, Mountain View, CA (US); Yushi Jing, San Francisco, CA (US)

(21) Appl. No.: 13/560,673

(22) Filed: Jul. 27, 2012

(51) Int. Cl. G06F 17/30

(52) U.S. Cl. CPC G06F 17/30274
USPC 707/758

(57) ABSTRACT

The specification relates to providing an image space. The image space represents a first sampling of images in increasing distance from a seed image. The first sampling shows a number of images an initial distance value from the seed image and representative images of image groups a distance value that is different from the initial distance value from the seed image. The system is capable of browsing and modifying the image space responsive to at least one input. When modified, the system provides a second sampling of the images in increasing distance from an image related to a target image. The second sampling shows a number of images a certain distance value from the image related to the target image and representative images of image groups a distance value that is different from the certain distance value from the image related to the target image.

### BACKGROUND

The subject matter described herein relates to the multi-resolution exploration of large datasets. An image retrieval system is a computer system for browsing, searching and retrieving images from a large database of digital images. Many image retrieval systems add metadata such as captioning, keywords, or descriptions to the images so that retrieval can be performed over the annotation words. This type of search is called an image meta search and allows a user to look for images using keywords or search phrases and often to receive a set of thumbnail images that reference image resources and may be sorted by relevancy.

In use, a user may perform an image search by searching for image content using an input query. The relevant images are then presented to a user and the user may browse all relevant images for a desired image. The image presented may include a static, graphic representative of some content, for example, photographs, drawings, computer generated graphics, advertisements, web content, book content or a collection of image frames, for example, a movie or a slideshow.

### SUMMARY

An interactive computer environment allows a user to browse a set of images for a desired, target image. First, a user will provide the system with a seed image. Upon receiving the seed image, the system will analyze the seed image and perform a ranking algorithm against a set of images using a set of distance measures. The ranking algorithm may be a real-time or near-real-time analysis wherein the seed image is ranked with all image files in real time or near real-time, or may use a pre-existing image hierarchical clustering previously performed by a back-end server, e.g., the seed image is ranked and then placed within a relevant leaf. Regardless of the ranking, the system will create an image space representing a sampling of the images in increasing distance from the seed data set, the distance being indicative of visual similarity between the seed image and the set of images. The sampling will show (1) a number of images an initial distance value from the seed image and (2) representative images of image groups a distance value that is different from the initial distance value from the seed image. In a hierarchy structure, the sampling may show all images in the leaf in which the seed image relates and a representative sample(s) of all nodes from leaf to the root.

A user can then browse the data space and choose an image that closely resembles a target image. Once the user finds a relevant image, the system will modify the image space by re-ranking the image space with respect to the relevant image. The re-ranked image space represents a second sampling of the images in increasing distance from the relevant image. This allows a user to interact with a dynamic image space that changes as a user chooses an image path and does not force a user into paths where the user must retrace steps if the search goes off course towards unwanted or non-related images.

In one aspect of the subject matter described in this specification, the methods comprise the steps of providing an image space. The image space represents a first sampling of images in increasing distance from a seed image. The seed image may be received from a conventional image search, a user upload, a query search, images cropped or cut from another image by a user, morphing multiple images into an image vector, or a command search related to a specific feature of the image.

The first sampling shows a number of images an initial distance value from the seed image and representative images of image groups a distance value that is different from the initial distance value from the seed image. The sampling is based on a distance measure that may analyze the visual aspects of the seed image including color, texture, size, shape, meta-data, hue, luminance, hard edges and soft edges of the seed image. The samplings may be presented as a logarithmic, one-dimensional representation of the images or a one-dimensional representation of a cluster hierarchy of the images.

The methods also include receiving at least one input to browse the image space and to identify a first image or images related to a target image. The methods then modify the image space responsive to the at least one input, to represent a second sampling of the images in increasing distance from the first image or images related to the target image. The second sampling shows a number of images a certain distance value from the first image or images related to the target image and representative images of image groups a distance value that is different from the certain distance value from the image related to the target image. The methods will modify the image space until receiving at least one input signifying the target image is found or the user is satisfied or finished.

In another implementation, a system comprises one or more processors and one or more computer-readable storage mediums containing instructions configured to cause the one or more processors to perform operations. The operations may include (1) providing an image space, the image space representing a first sampling of images in increasing distance from a seed image, the first sampling showing a number of images an initial distance value from the seed image and representative images of image groups a distance value that is different from the initial distance value from the seed image, (2) receiving at least one input to browse the image space to identify a first image or first set of images related to a target image and (3) modifying the image space responsive to the at least one input, to represent a second sampling of the images in increasing distance from the first image or first set of images related to the target image, the second sampling showing a number of images a certain distance value from the first image or first set if images related to the target image and representative images of image groups a distance value that is different from the certain distance value from the image related to the target image. The system may also perform operations that modify the image space until receiving at least one input signifying the target image is found.

In another implementation, a computer-program product tangibly embodied in a machine-readable storage medium may include instructions configured to cause a data processing apparatus to: (1) provide an image space, the image space representing a first sampling of images in increasing distance from a seed image, the first sampling showing a number of images an initial distance value from the seed image and representative images of image groups a distance value that is different from the initial distance value from the seed image, (2) receive at least one input to browse the image space and to identify an image related to a target image and (3) modify the image space responsive to the at least one input, to represent a second sampling of the images in increasing distance from the image related to the target image, the second sampling showing a number of images a certain distance value from the image related to the target image and representative images of image groups a distance value that is different from the certain distance value from the image related to the target image. The product may also include instructions configured to cause a data processing apparatus to modify the image space until receiving at least one input denoting the target image is found.

### BRIEF DESCRIPTION OF THE DRAWINGS

FIG. 1a is a flow chart showing an example of the disclosed technology;

FIG. 1b is a flow chart showing an example of the disclosed technology;

FIG. 1c is a flow chart showing an example of the disclosed technology;

FIGS. 2-4 are examples of pictorial representations of an image space in relation to the disclosed technology;

FIG. 5 is a diagram showing an example of a hierarchical structure;

FIGS. 6-7 are pictorial representations of an example image space in relation to the disclosed technology; and

FIG. 8 is a block diagram of an example of a system used with the disclosed technology.

### DETAILED DESCRIPTION

An interactive computer environment and system allows a user to browse a set of images for a target image. The system efficiently explores large data sets, such as images, and allows a user to take a sequence of actions relating to the exploration of an image space, taking large steps at first to find the desired type of images, followed by smaller steps, until finally arriving at a desired or target image or set of images. The image space may be defined as a visual representation of image resources to a user and may be presented to a user on a display or a similar device, as will be described more fully below.

In a particular implementation, images are searched, however, the system is capable of applying the disclosed technology to any data where a distance measure can be applied including video, text documents, audio, meta-data and others.

In one implementation, the image space is provided to the user as linear, as this model best fits with the most common user interface models and allows efficient use of screen space, which is especially important for small screen displays, such as, mobile phones and tablets. The system performs an image ranking based on a seed image and the ranking shows a sub-sampling of images in the order of increasing distance from the seed. This enables the user to navigate to the desired parts of the image space by browsing through the sub-sampling of the images.

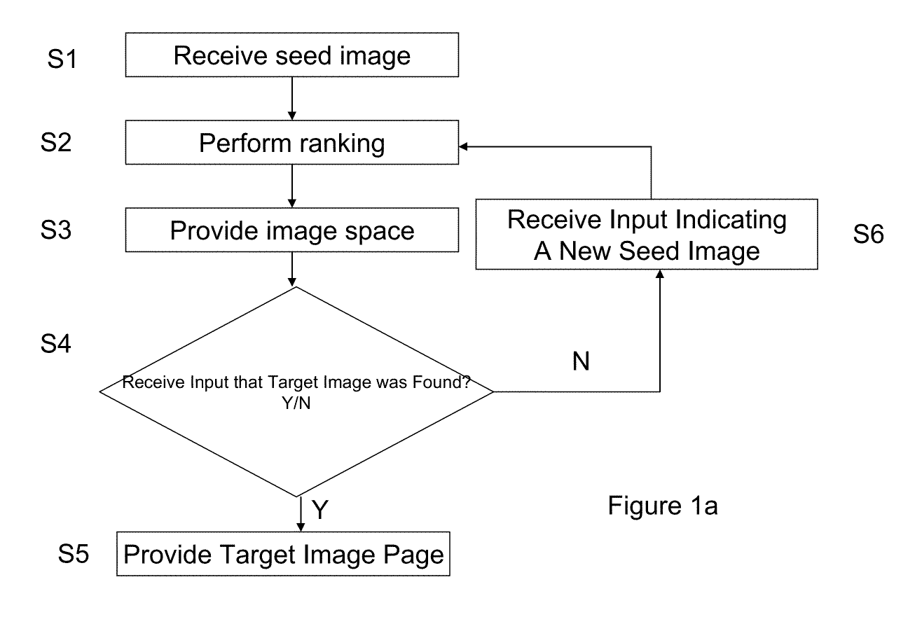

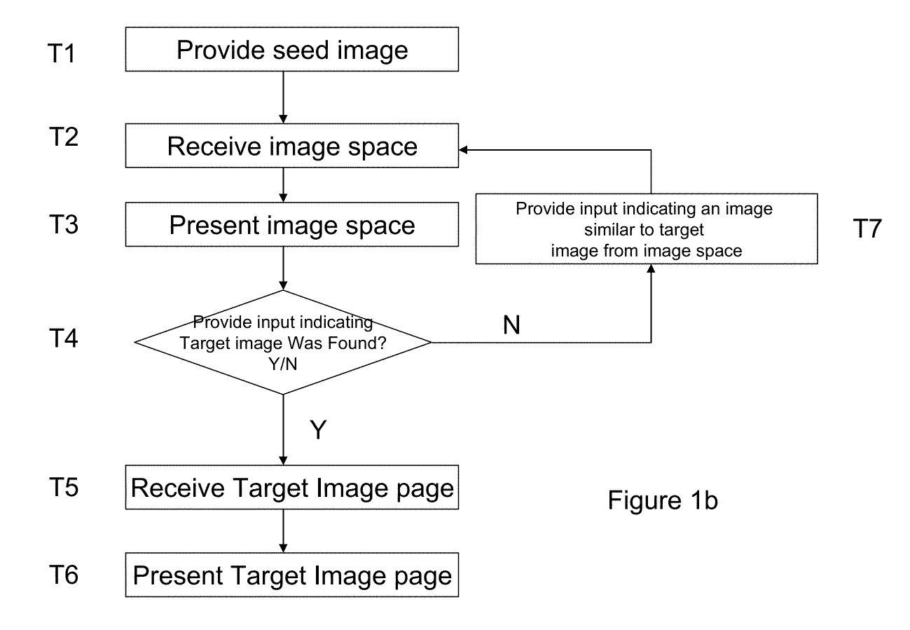

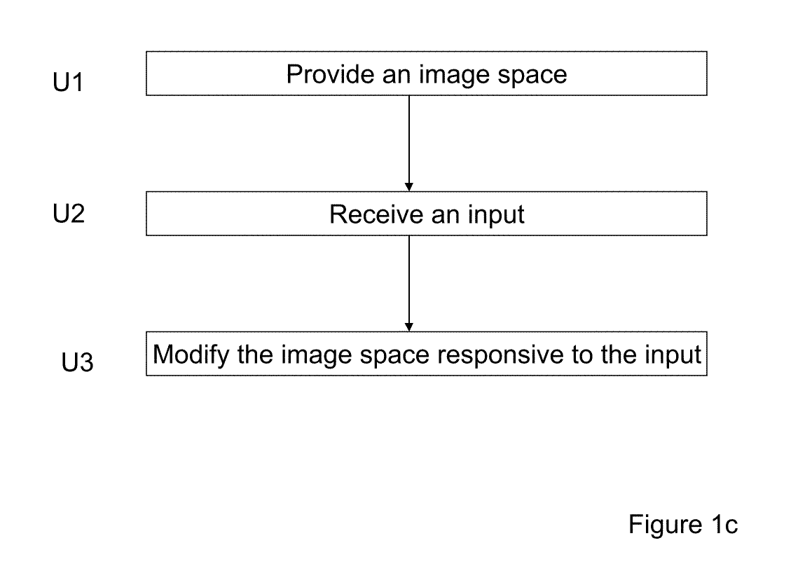

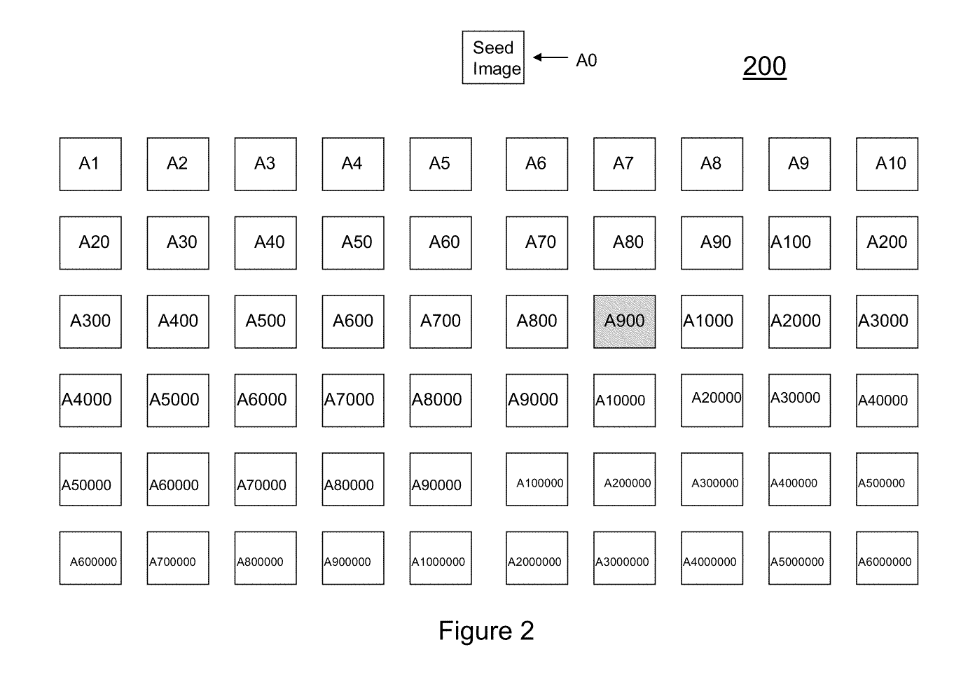

FIG. 1a is a flow diagram showing a method for providing an image space. The image space in FIG. 2 shows a representative set of images based on similarity to a seed image.

For convenience, the methods will be described with respect to a system including one or more computing devices as will be described more fully below. Typically, representations of the image resources, e.g., a thumbnail are presented rather than the actual image resources themselves, although it is possible to present the actual image resources. For convenience, the term image in the specification refers to either an image resource or a representation of the image resource.

As shown in FIG. 1a, step S1, a seed image is received by the system. This seed image may be supplied through a conventional image search text query, an image upload, a query search, images cropped or cut from another image by a user, morphing multiple images into an image vector, or a command search related to a specific feature of the image.

In Step S2, upon receiving the seed image, the system analyzes the seed image and performs a ranking algorithm against an image set using a set of distance measures. The image set may contain anywhere from a few hundred images to millions of images. The ranking algorithm may be a real-time or real-near time analysis, e.g., seed is ranked with all image files in real time or near real-time or the system may use a pre-existing hierarchical image cluster that was previously generated by a back-end server, seed is ranked and then placed within its proper cluster grouping.

In either case, a ranking engine ranks images responsive to the seed image according to one or more criteria as will be described more fully below. In Step S3, the system provides an image space. The image space may be a one-dimension representation that shows images visually similar or that corresponds in some characteristics to the seed image at various distance values from the seed image(s). The representation may be a logarithmic or hierarchical sub-sampling of the results and presents a range of distances for the images.

After an image space is provided, a user reviews the image space and tries to locate a target image. If the target image is found, the user will indicate that the target image was found by clicking on that image or on a link located beneath the image (Step S4) and the server, in response to the indication, may provide a target image page, e.g., the server may automatically jump to a webpage or landing page related to the target image (Step S5). The user may then use the target image page as the user deems appropriate. For example, the user may use the target image page as a foundation for a product search and by clicking on the target image pricing and reviews associated with the target image may be retrieved from multiple online stores. In another example, the process may stop when the user clicks a link telling the system the target image was found or clicks the image and is sent to a landing page. The link may be the picture itself or a link located below the image or the search itself may be the product search, e.g., once the target image is chosen, the user can click on the target image and buy the item.

If the target image is not found within the provided image space, the user may continue the search by choosing and clicking on a new seed image that best represents, or most closely resembles the target image. (Step S6). In one implementation, the user may choose multiple images that may combined as a single image vector and used as the representative image. This representative image or image vector may be closely related to the seed image or may be some distance away from the seed image. Once this representative image is received by the system, the system will re-rank the images and provide the user with a new image space using the representative image as the seed image (Step S3). That is, the image space may present a sub-sampling of the image set with increasing distance from the representative image. This process may be repeated until the user finds the target image. The process may stop when the user clicks a link telling the system the target image was found or clicks the image and is sent to a landing page. The link may be the picture itself or a link located below the image.

FIG. 1b is a flow diagram showing a method for providing a seed image. As shown in FIG. 1b, step T1, a seed image is provided to the system through a conventional image search text query, an image upload, a query search, images cropped or cut from another image by a user, morphing multiple images into an image vector, or a command search related to a specific feature of the image.

In Step T2, the user receives an image space. The image space may then be presented to the user (Step T3). The image space may be a visual representation of the image space that presents a ranking of images. For example, the image space may be a one-dimensional representation that shows images close to the seed image and images that are visually similar or that correspond in some characteristics to the seed image but are a farther distance value away from seed image.

After reviewing the image space, the user may indicate in Step T4 if the target image was found. If the target image was found, the user may select the target image in Step T4 by clicking on the target image. In Step T5, the user then receives a target image page, such as, a webpage or landing page related to the target image. The target image page is then presented to the user. (Step T6).

If the target image was not found, the user in Step T7 may provide an input indicating an image the user finds similar to the target image. In other words, the user may select a link located beneath an image that indicates that the user believes the selected image(s) is related to the target image and would like to designate the selected image(s) as the new seed image(s) for re-ranking. These steps may be repeated until the user finds the target image.

FIG. 1c is a flow diagram showing a method for providing an image space. (Step U1). The image space represents a first sampling of images in increasing distance from a seed image. The first sampling shows a number of images an initial distance value from the seed image and representative images of image groups a distance value that is different from the initial distance value from the seed image. In Step U2, the system receives at least one input to browse the image space and to identify an image related to a target image. In Step U3, the system then modifies the image space responsive to the at least one input and provides a second sampling of the images in increasing distance from the image related to the target image. The second sampling shows a number of images a certain distance value from the image related to the target image and representative images of image groups a distance value that is different from the certain distance value from the image related to the target image.

In one implementation of the disclosed technology, the ranking engine may employ a real-time or real-near time ranking analysis. In this implementation, the ranking engine may compute a similarity matrix. This similarity matrix generally may include an N×N matrix of image results where each entry in the matrix is a similarity value associating two images. The similarity value represents a score identifying the similarity between a pair of images. Similarity can be calculated, for example, using color, texture, shape, or other image-based signals. In some implementations, image metadata is used in calculating similarity. For example, metadata identifying a location where, or time when, the image was captured, external information including text associated with the image, e.g., on a webpage, or automatically extracted metadata.

The system may also compute the similarity metrics according to one or more similarity metrics for the images. The similarity metrics can be based on features of the images. A number of different possible image features can be used including intensity, color, edges, texture, wavelet based techniques, or other aspects and characteristics of the images. For example, regarding intensity, the system can divide each image into small sections, e.g., rectangles, circles, and an intensity histogram can be computed for each section. Each intensity histogram can be considered to be a metric for the image.

As an example of a color-based feature, the system can compute a color histogram for each section or different sections within each image. The color histogram can be calculated using any known color scheme including the RGB (red, green, blue) color space, YIQ (luma (Y) and chrominance (IQ), or another color space. Histograms can also be used to represent edge and texture information. For example, histograms can be computed based on sections of edge information or texture information of an image.

For wavelet based techniques, in one example, a wavelet transform may be computed for each section and used as an image feature. The similarity metrics can alternatively be based on text features, metadata, user data, ranking data, link data, and other retrievable content.

The similarity metrics can also pertain to a combination of similarity signals including content-based, such as, color, local features, facial similarity, text, etc., user behavior based, and text based, such as, computing the similarity between two sets of text annotations. Additionally, text metadata associated with the images can be used, for example, file names, labels, or other text data associated with the images. When using local features, the system may compute the similarity based on the total number of matches normalized by the average number of local features. The similarity matrix or other structure can then be generated for the particular one or more similarity metrics using values calculated for each pair of images.

Overall, lower distance values are given to more similar images and higher distance values are given for dissimilar images. Once a matrix has been created for a seed image, the system will create an image space representing a sub-sampling of the image set in increasing distance from the seed image.

FIGS. 2-4 show examples of dynamic image spaces 200, 300, 400, respectively. As described above, a user supplies the system with a seed image. This may happen by either finding an image during a conventional image query or by uploading a photograph or some other type of image, image data or resource. The system will then analyze the seed image against the image set and provide a sub-sampling of the ranking. The image space 200 is represented by images shown in increasing distance from the seed image. In this example, FIG. 2 shows a first sub-sampling of the images being presented to a user. The image space 200 is represented by (1) 10 images having the lowest distance values in relation to the seed image, (2) every tenth image from 10-100, (3) every hundredth from 100-1000, (4) every one thousandth from 1,000-10,000, (5) every ten thousandth from 10,000-100,000, (6) every one hundred thousandth from 100,000-1,000,000, (7) every millionth from 1,000,000 to the end of the image set. In this example, the image set contains 6 million images but larger and smaller image steps are contemplated depending on the size of the image set and the amount of images that are to be presented. Other sampling methods are contemplated such as a logarithmic sampling where the image space shows images at positions alphâk where k is an integer position in the sub-sampled list and alpha>1 is a constant.

Also shown in FIG. 2 is a representation of the seed image A0. This representation is shown at the top of the image space 200. This representation is useful for presenting the seed image to a user during a search but this feature is not needed for the implementation of the disclosed technology. In another implementation, there may be a scrolling bar at the top of the image space that represents the image history of the search, e.g., a scrolling bar shows the seed image and all similar images chosen during the search.

In this example, image A900 is highlighted to depict that the user chose this image as the image that best represents, or most closely resembles, the user's target image. Once this image A900 is chosen, the system will use this image A900 as the new seed image.

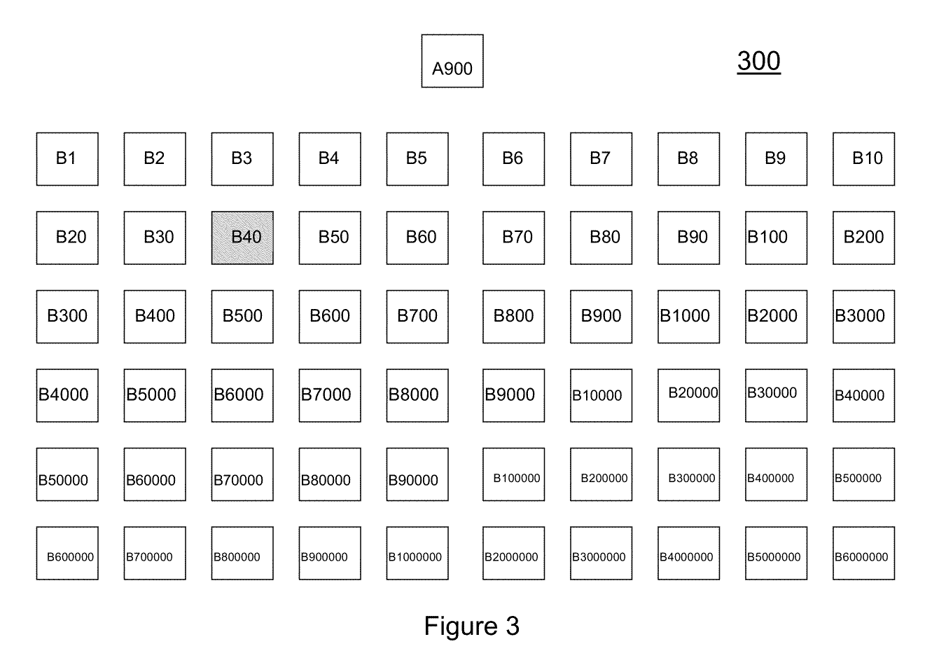

FIG. 3 shows an image space 300 recalculated using image A900 as the new seed image. The image space 300 is represented by (1) 10 images having the lowest distance values in relation to image A900, (2) every tenth image from 10-100, (3) every hundredth from 100-1000, (4) every one thousandth from 1,000-10,000, (5) every ten thousandth from 10,000-100,000, (6) every one hundred thousandth from 100,000-1,000,000, (7) every millionth from 1,000,000 to the end of the image set.

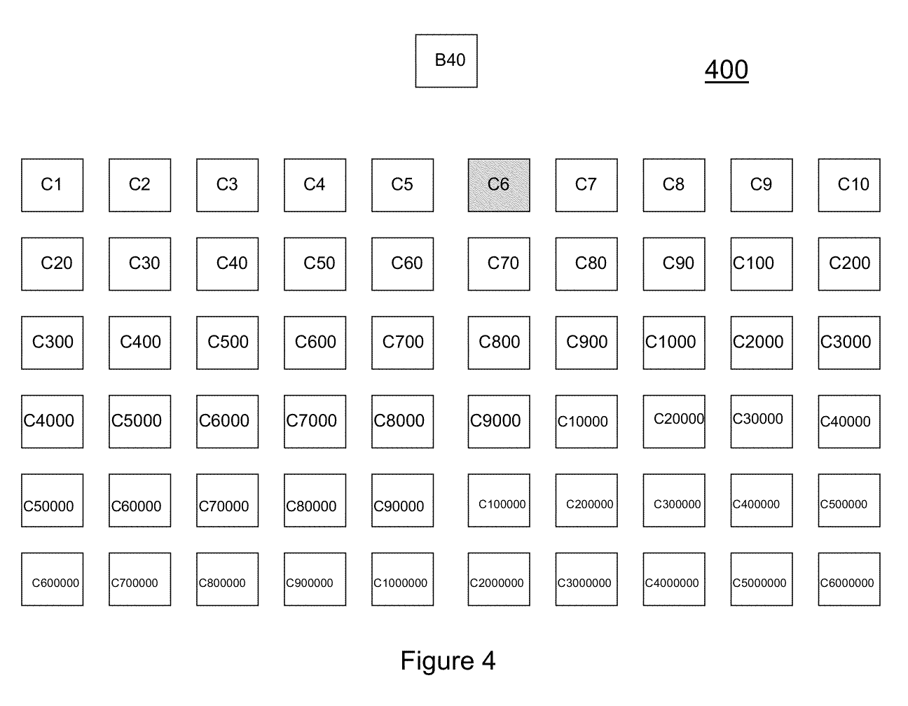

After presenting the new image space 300 to the user, the user may browse the image space 300 and choose an image as a target image or a relevant image. In this example, the user chose image B40 as an image that closely represents a likeness to the target image. The system then again re-populates the image space using image B40 as the new seed image and presents the results to the user in FIG. 4. Here the user selects the target image C6 and after browsing the updated image space. Once selected, the user may use this image in a product search, store the image for use off-line, download the image or upload the image to another application. The target image may be designated as such by clicking on the desired image or clicking on a link below the image. Once clicked, the user may be directed to a landing page or some product location.

Presenting a one-dimensional image space to a user in this fashion provides, at any point during an image search, a user with images, set of images or representations of images of different distances in relation to the seed image. A user may always see a range of images different distances from the seed image. If a search goes off course tending away from a target image, the user does not have to backtrack through the prior search results. A user may merely choose the image that best represents a target image and the image space will be re-populated accordingly. Also, computing resources may be used more effectively and efficiently since we are recalculating the image space using all available images.

In an implementation of the disclosed technology, a cluster analysis may be performed. That is, the system will create an image space representing a sampling of the images in increasing distance from the seed data set using a hierarchy sampling structure that shows all images in the leaf in which the seed image relates and a representative sample(s) of all nodes from leaf to the root.

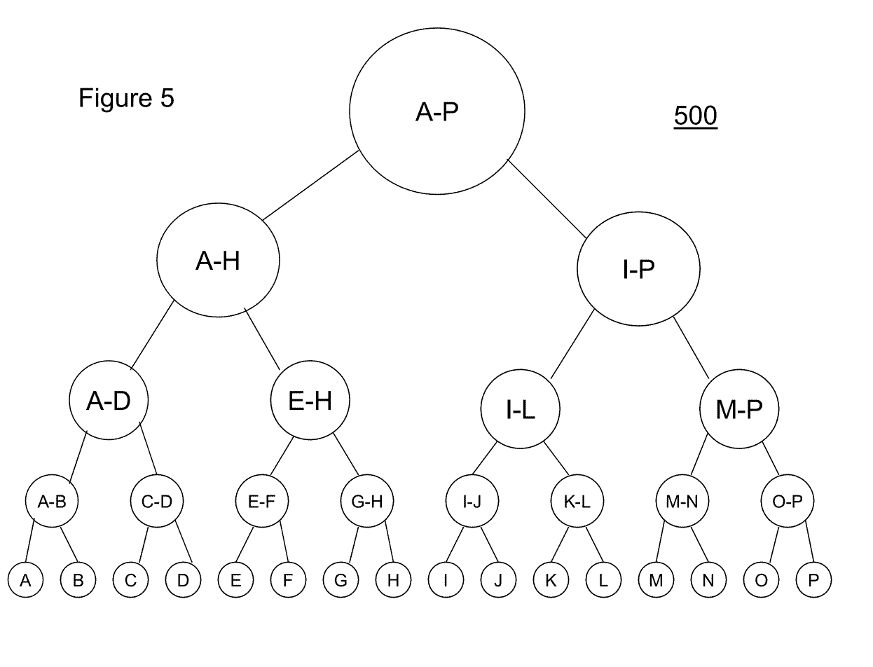

In this implementation, the ranking engine computes where within a pre-existing cluster a seed image should be ranked. FIG. 5 shows a low-level hierarchical cluster for explanation purposes. When using a pre-existing hierarchical clustering previously performed by a back-end server, the similarity matrix can be computed for each unique pair of images in the image set. For example, the system can construct a similarity matrix by comparing images within a set of images to one another on a feature by feature basis. Thus, each image has a similarity value relative to each other image of the search results.

The system can then use clustering techniques to perform a first level grouping of the images, such as, an initial clustering of images identified from the image set. The first level grouping of images can include clustering data using one or more hierarchical data clustering techniques, for example, according to a similarity, such as, visual, non-visual, or both between images identified in the image set. In some implementations, the system may use additional external inputs when generating hierarchical image clusters.

The system generates a hierarchical cluster of image search results using the similarity matrix and according to a particular clustering technique. In particular, the similarity value for each pair of images can be treated as a distance measure. The system can then cluster the images according to a particular threshold distance. The threshold can, for example, provide a minimum number of clusters, or a minimum acceptable similarity value, to select an image for membership to a specific cluster. An example of a clustering technique is shown in FIG. 5. In this implementation, similar groups of images are further grouped or categorized together in increasingly larger clusters, which allows the system to navigate through the layers of the hierarchy and present representative images accordingly.

The system may generate a hierarchical cluster of images using the similarity matrix and one or more additional image similarity measures. The additional image measures can, for example, include color, texture, shape, or other image-based signals. Additionally, non-image signals can be used to provide a similarity measure including, for example, text, hyperlinks, and user interaction data.

After generating a hierarchical clustering of images using the similarity matrix, the system identifies a canonical image for each cluster. For example, the system identifies which image within each image cluster to promote or designate as the representative image for that particular cluster. The selection of a canonical image for each image cluster provides a “visual summary” of the semantic content of a collection of images. The “visual summary” also provides a mechanism to navigate a large number of images quickly.

The canonical image can be selected using a combination of one or more ranking mechanisms, mathematical techniques, or graphical techniques. The system can calculate the canonical images for each image cluster using an image ranking score, promoting the highest ranked image, computing an image similarity graph using image search results to determine a particular relevancy score for an image, using additional signals, e.g., quality scores, image features, and other content based features.

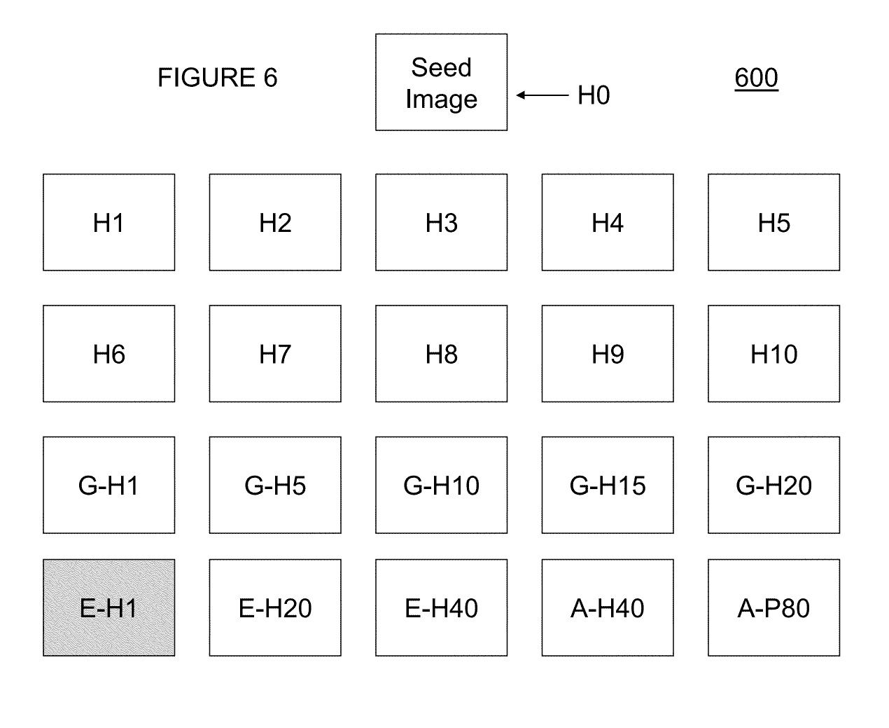

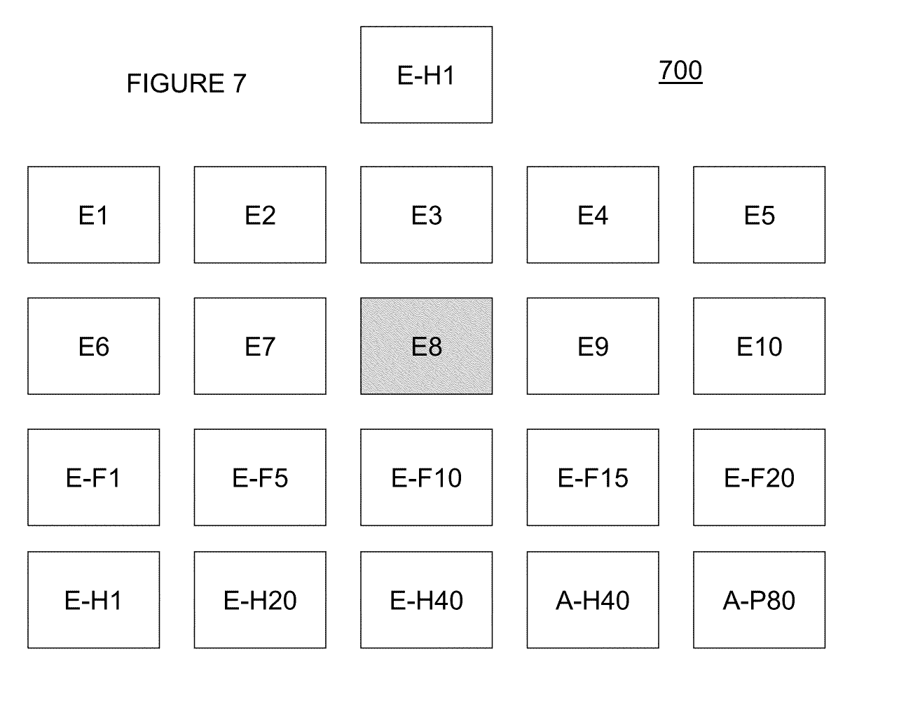

FIGS. 6-7 show an example of an image space using a hierarchical structure 500. A hierarchical clustering of ranked images is generated and stored within the system. A user then supplies the system with a seed image. The system will then analyze the seed against the image set and assign the image to a leaf of the tree that most closely resembles the seed image. In some instances, the image may already be an image within the image set. If this happens, the system will identify the leaf to which the image already belongs. In this example, the image was assigned to leaf H. The image space 600 is then presented to the user in a fashion programmed by the system. For example, the image space 600 may present sets of images for all nodes on the path from the leaf up to the root, where the number of images per node may be constant. For each node up from the leaf, the image space may present a random sample of images within the nodes, centers of these nodes, the canonical image of the node, or some other format which best fits the image space requirements.

In the example shown in FIGS. 6-7, the image space 600 presented all images H1-10 belonging to Node H. Up from that node was Node G-H. Node G-H held 20 images and the image space presented five images from that node—the first image G-H1, the middle image G-H10, the last image G-H20, and two images G-H5, G-H15 equidistant from the first image to the middle image and the middle image to last image. Up from that node was Node E-H. Node E-H held 40 images and three images were presented—first image E-H1, the last image E-H40 and a canonical image E-H20. Up from that node, Node A-H held 80 images and the canonical image A-H40 for that node was presented. Up from that node was the root node. The root node held 160 images and was presented by its canonical image A-P80.

The user could have browsed this image space 600 and chosen Image E-H1 as the image most resembling the desired target image. As shown in FIG. 7, the system re-calculated the image space displaying all images in Node E and their representative images from the leaf up to the root. The user could have then chosen image E8 as the target image.

This example was shown with only 180 images being represented in the image set but the hierarchical image set may be formulated to contain any amount of images and the image space presented may contain as many images as can be represented on a single display screen. In another example, the image space may be presented using a spilling technique that ensures that when presenting images from an intermediate node, all children of this node are represented in the image space, the center of the children nodes one or two levels below the intermediate node are presented.

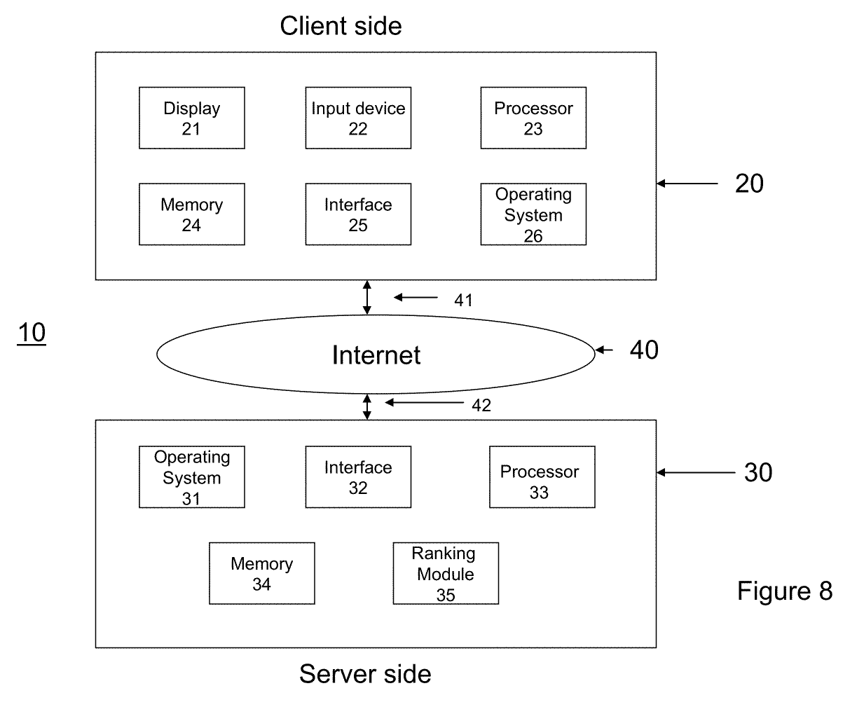

FIG. 8 is a schematic diagram of an example of a system for presenting image search results. The system includes one or more processors 23, 33, one or more display devices 21, e.g., CRT, LCD, one or more interfaces 25, 32, input devices 22, e.g., keyboard, mouse, etc., and one or more computer-readable mediums 24, 34. These components exchange communications and data using one or more buses 41, 42, e.g., EISA, PCI, PCI Express, etc.

The presenting can be performed by a device 20 at which the images are displayed, or a server device can present the user interface by sending code to a receiving device that renders the code to cause the display of the user interface being presented. Once the image space is created, a user can browse the image space and choose an image that most closely resembles a target image. The system 10 modifies the user interface in response to input by the user from the displayed images. Moreover, such modification can be performed by the device on which the images are displayed using code sent by a server device 30 in one communication session, or through ongoing interactions with a server system.

That is, once the user finds a relevant image, the system will modify the image space by re-ranking the image space with respect to the relevant image. The re-ranked image space represents a second sampling of the images in increasing distance from the relevant image.

These methods allow a user to interact with a dynamic image space that changes as a user chooses an image path and does not force a user into certain paths where the user must retrace steps if the search goes off course towards undesired images.

The term “computer-readable medium” refers to any non-transitory medium 24, 34 that participates in providing instructions to processors 23, 33 for execution. The computer-readable mediums 24, 34 further include operating systems 26, 31 with network communication code, image grouping code, images presentation code, and other program code.

The operating systems 26, 31 can be multi-user, multiprocessing, multitasking, multithreading, real-time, near real-time and the like. The operating systems 26, 31 may perform basic tasks, including but not limited to: recognizing input from input devices 22; sending output to display devices 21; keeping track of files and directories on computer-readable mediums 24, 34, e.g., memory or a storage device; controlling peripheral devices, e.g., disk drives, printers, etc; and managing traffic on the one or more buses 41, 42.

The network communications code may include various components for establishing and maintaining network connections, e.g., software for implementing communication protocols, e.g., TCP/IP, HTTP, Ethernet, etc.

The image grouping code may provide various software components for performing the various functions for grouping image search results, which can include clustering or otherwise assessing similarity among images. The images presentation code may also provide various software components for performing the various functions for presenting and modifying a user interface showing the image search results.

Moreover, as will be appreciated, in some implementations, the system of FIG. 8 is split into a client-server environment communicatively connected over the internet 40 with connectors 41, 42, where one or more server computers 30 include hardware as shown in FIG. 8 and also the image grouping code, code for searching and indexing images on a computer network, and code for generating image results for submitted queries, and where one or more client computers 20 include hardware as shown in FIG. 8 and also the images presentation code, which can be pre-installed or delivered in response to a query, e.g., an HTML page with the code included therein for interpreting and rendering by a browser program.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, e.g., one or more modules of computer program instructions, encoded on a computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be, or be included in, a computer-readable storage device, a computer-readable storage substrate, a random or serial access memory array or device, or a combination of one or more of them.

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or combinations of them. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, e.g., a virtual machine, or a combination of one or more of them. The apparatus and execution environment can realize various different computing model infrastructures, e.g., web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network, e.g., the Internet, and peer-to-peer networks, e.g., ad hoc peer-to-peer networks.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a client device, e.g., for purposes of displaying data to and receiving user input from a user interacting with the client device. Data generated at the client device, e.g., a result of the user interaction, can be received from the client device at the server.

While this specification contains many specific implementation details, these should not be construed as limitations on the scope of the disclosed technology or of what may be claimed, but rather as descriptions of features specific to particular implementations of the disclosed technology. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. In some cases, the actions recited in the claims can be performed in a different order and still achieve desirable results. Moreover, the separation of various system components in the implementations described above should not be understood as requiring such separation in all implementations, and it should be understood that the described program components and systems can generally be integrated together in a single software product or packaged into multiple software products.

The systems and techniques described here can be applied to videos or other visual contents, and they can also be applied to various sources of images, irrespective of any image search or images search results, e.g., a photo album either in the cloud or on the user's computer, stock photo collections, or any other image collections.

The foregoing Detailed Description is to be understood as being in every respect illustrative, but not restrictive, and the scope of the disclosed technology disclosed herein is not to be determined from the Detailed Description, but rather from the claims as interpreted according to the full breadth permitted by the patent laws. It is to be understood that the implementations shown and described herein are only illustrative of the principles of the disclosed technology and that various modifications may be implemented without departing from the scope and spirit of the disclosed technology.

1. A method comprising the steps of:
providing an image space, the image space representing a first sampling of images in increasing distance from a seed image, the first sampling showing a number of images an initial distance value from the seed image and representative images of image groups a distance value that is different from the initial distance value from the seed image;
receiving at least one input to browse the image space and to identify an image related to a target image;
modifying the image space responsive to the at least one input, to represent a second sampling of the images in increasing distance from the image related to the target image, the second sampling showing a number of images a certain distance value from the image related to the target image and representative images of image groups a distance value that is different from the certain distance value from the image related to the target image.

2. The method of claim 1 further comprising the step of:
modifying the image space until receiving at least one input signifying the target image is found.

3. The method of claim 3 wherein the seed image is received from one of an image search, a user upload, a query search, images cropped by a user, images cut by a user, morphing multiple images into an image vector, or a command search related to a specific feature of the image.

4. The method of claim 1 wherein the first sampling and the second sampling is one of a logarithmic, one-dimensional representation of the images and a one-dimensional representation of a cluster hierarchy of the images.

5. The method of claim 1 wherein the first sampling and the second sampling is based on a distance measure.

6. The method of claim 5 wherein the distance measure analyzes at least one of color, texture, size, intensity, shape, meta-data, hue, luminance, hard edges and soft edges.

7. The method of claim 1 wherein the increasing distance is based on visual aspects of the seed image.

98. A system comprising:
one or more processors;
one or more computer-readable storage mediums containing instructions configured to cause the one or more processors to perform operations including:
providing an image space, the image space representing a first sampling of images in increasing distance from a seed image, the first sampling showing a number of images an initial distance value from the seed image and representative images of image groups a distance value that is different from the initial distance value from the seed image;
receiving at least one input to browse the image space and to identify an image related to a target image;
modifying the image space responsive to the at least one input, to represent a second sampling of the images in increasing distance from the image related to the target image, the second sampling showing a number of images a certain distance value from the image related to the target image and representative images of image groups a distance value that is different from that certain distance value from the image related to the target image.

9. The system of claim 8 further comprising an operation of:
modifying the image space until receiving at least one input signifying the target image is found.

10. The system of claim 9 wherein the seed image is received from one of an image search, a user upload, a query search, images cropped by a user, images cut by a user, morphing multiple images into an image vector, or a command search related to a specific feature of the image.

11. The system of claim 8 wherein the first sampling and the second sampling is one of a logarithmic, one-dimensional representation of the images and a one-dimensional representation of a cluster hierarchy of the images.

12. The system of claim 8 wherein the first sampling and the second sampling is based on a distance measure.

13. The system of claim 12 wherein the distance measure analyzes at least one of color, texture, size, intensity, shape, meta-data, hue, luminance, hard edges and soft edges.

14. The system of claim 8 wherein the increasing distance is based on visual aspects of the seed image.

15. A computer-program product, the product tangibly embodied in a machine-readable storage medium, including instructions configured to cause a data processing apparatus to:
provide an image space, the image space representing a first sampling of images in increasing distance from a seed image, the first sampling showing a number of images an initial distance value from the seed image and representative images of image groups a distance value that is different from the initial distance value from the seed image;
receive at least one input to browse the image space and to identify an image related to a target image;
modify the image space responsive to the at least one input, to represent a second sampling of the images in increasing distance from the image related to the target image, the second sampling showing a number of images a certain distance value from the image related to the target image and representative images of image groups a distance value that is different from the certain distance value from the image related to the target image.

16. The computer-program product of claim 15 further comprising the step of:
modifying the image space until receiving at least one input signifying the target image is found.

17. The computer-program product of claim 15 wherein the first sampling and the second sampling is one of a logarithmic, one-dimensional representation of the images and a one-dimensional representation of a cluster hierarchy of the images.

18. The computer-program product of claim 15 wherein the first sampling and the second sampling is based on a distance measure.

19. The computer-program product of claim 18 wherein the distance measure analyzes at least one of color, texture, intensity, size, shape, meta-data, hue, luminance, hard edges and soft edges.

20. The computer-program product of claim 15 wherein the increasing distance is based on visual aspects of the seed image.
